(19) United States
(12) Patent Application Publication
(10) Pub. No.: US 2025/0292933 A1
(43) Pub. Date: Sep. 18, 2025

(54) LONGITUDINAL CABLE FOR ELECTRICAL POWER TRANSMISSION, AIRCRAFT PROPULSION CHAIN AND ASSOCIATED METHODS

(71) Applicant: SAFRAN ELECTRICAL & POWER, BLAGNAC Cedex (FR)

(72) Inventors: Laurent Pierre François Jules AZEMARD, MOISSY CRAMAYEL (FR); Jérôme GENOULAZ, MOISSY CRAMAYEL (FR)

(21) Appl. No.: 19/077,220

(22) Filed: Mar. 12, 2025

(30) Foreign Application Priority Data
Mar. 14, 2024 (FR) 2402534

(51) Int. Cl. H01B 9/00; B64D 47/00

(52) U.S. Cl. CPC H01B 9/006; B64D 47/00; B64D 2221/00

(57) ABSTRACT

A longitudinal cable including a first conductor, a first semiconductor layer, a first insulating layer, the first conductor including a plurality of conductor wires each including a conductive strand which is covered by an insulation sheath, the first conductor including at least one longitudinal discontinuous groove at the periphery uncovering the conductive strand of the conductor wires at the level of a contact zone, each uncovered conductive strand being a smoothing conductive strand, each smoothing conductive strand including longitudinal portions covered by an insulating sheath and uncovered longitudinal portions, the uncovered longitudinal portions being in contact with the first semiconductor layer at the level of a contact zone, the contact zones being spaced apart by the same contact pitch.

### TECHNICAL FIELD

The present invention relates to the field of electrical power transmission through a cable, in particular, for an aeronautical application.

The climate change is a major concern for many legislative and regulatory members throughout the world. In fact, various restrictions on carbon emissions have been, are being or will be adopted by different countries. In particular, an ambitious standard applies both to new aircraft types and to those already in circulation, requiring the implementation of technological solutions to bring them into line with current regulations. The civil aviation industry has been mobilizing for several years now to make a contribution to the fight against climate change.

The technological research efforts have already allowed for a very significant improvement in the environmental performance of the aircrafts. The Applicant takes into consideration the impacting factors in all phases of design and development to obtain aeronautical components and products that are more energy efficient, more environmentally friendly and whose integration and use in civil aviation have moderate environmental consequences with the aim of improving the energy efficiency of aircrafts.

Consequently, the Applicant is constantly working to reduce its negative impact on the climate through the use of virtuous development and manufacturing methods and processes that minimize the greenhouse gas emissions to the minimum possible in order to reduce the environmental footprint of its activity.

This sustained research and development work focuses on new generations of aircraft engines, making aircraft lighter, particularly through the materials used and lighter on-board equipment, developing the use of electrical technologies for propulsion, and, as an essential complement to technological progress, aeronautical biofuels.

An electric or hybrid aircraft classically comprises a propulsion chain with electric motors that must be powered by a high-power electrical supply, i.e. with a high voltage (230V-3000V) at a high frequency (400 Hz-3000 Hz) and a high current (100 A-1000 A).

To this end, the propulsion chain comprises a plurality of longitudinal cables that are distributed throughout the aircraft to connect different electrical equipment. The electrical equipment takes the form of generators, electronic power devices, electric motors, etc.

A cable must be able to carry high power, but also have a small footprint and low mass to enable it to be integrated into an aircraft without penalizing its power consumption. To this end, with reference to FIG. 1, a cable of the “coaxial” type 100 is known in the prior art which extends longitudinally along an axis X1 and comprises:
a first conductor 101,
a first semiconductor layer 102 surrounding the first conductor 101,
an insulating layer 103 surrounding the first semiconductor layer 102,
a second semiconductor layer 104 surrounding the insulating layer 103, and
two insulating sheaths 105, 106.

In practice, when an alternating current or a pulse-width-modulated current flows, the cable 100 heats up more significantly for conditions of conductor size relative to the electrical frequency of the current, due to so-called “skin effect” and proximity effect phenomena. Also, to avoid the risk of unwanted heating, it is necessary to limit the power transmitted by reducing, for example, the current intensity or to reduce the electrical resistance of the conductor by increasing, for example, the size of the conductor.

To eliminate this drawback, with reference to FIG. 2, a cable of the type “Litz” 200 is known in the prior art, extending longitudinally along an axis X2, comprising a plurality of conductor wires 210 which are electrically insulated from one another. Each conductor 210 comprises a conductive strand 211 which is covered by an insulating sheath 212. The conductor wires 210 are twisted to form the conductor, which may then be protected by insulating sheaths 202, 203. Advantageously, the electric current may flow evenly through each conductive strand 211.

A cable 200 of the Litz type does not contain the electric field as securely as a coaxial cable 100. Indeed, in a cable of type “coaxial” 100, the semiconductor layer 102 allows to smooth the electric field from the first conductor 101. The presence of the semiconductor layers 102 and 104 on either side of the insulating layer 103 allow the electric field to be optimally contained within the insulating layer 103.

To smooth the electric field from a conductor 101, the semiconductor layer 102 must be at the same electric potential as said conductor 101. Also, the use of a semiconductor layer 102 cannot be used with a cable 200 of the Litz type, as the conductor wires 210 are electrically insulated from each other and therefore cannot be in electrical contact with the environment.

The invention thus aims to eliminate at least some of these disadvantages by proposing a cable for the transmission of electrical power that avoids any risk of additional heating due to the “skin effect” and proximity effect, while allowing for increased electrical safety.

Although the invention was originally conceived for a cable of the type “coaxial”, the present invention also applies to a simple cable whose insulation has at least one semiconductor layer.

### PRESENTATION OF THE INVENTION

The invention relates to a longitudinal cable for transmitting electrical power, the longitudinal cable comprising:
A first conductor,
A first semiconductor layer surrounding the first conductor,
A first insulating layer surrounding the first semiconductor layer,
the first conductor having a periphery in contact with the first semiconductor layer, the first conductor comprising:
   a plurality of conductor wires each comprising a conductive strand which is covered by an insulating sheath so that the conductive strands are electrically insulated from one another,
   the first conductor comprising at least one discontinuous longitudinal groove at the periphery uncovering the conductive strand of the conductor wires at the level of a contact zone, each uncovered conductive strand being a smoothing conductive strand, each smoothing conductive strand comprising longitudinal portions covered with an insulating sheath and uncovered longitudinal portions, the uncovered longitudinal portions being in contact with the first semiconductor layer at the level of the contact zone so that the first semiconductor layer has the same electrical potential as the smoothing conductive strand, the contact zones being spaced apart by the same contact pitch.

Advantageously, the result is a cable which, on the one hand, ensures optimum smoothing of the electric field and, on the other hand, minimal heating due to the “skin effect” and proximity effect. Advantageously, one or more smoothing conductors are used to conduct power and equalize electrical potential (equipotentiality), while the other conductive strands are insulated to reduce skin effect and proximity effect. The resulting cable has a limited mass and a small footprint. The cable is perfectly suited to the transmission of high AC or PWM (Pulse Width Modulation) power at high altitudes. This allows to increase the performance of electrical insulation by reducing partial discharge phenomena, the local reinforcement phenomena of the electric field, the space charge phenomena and the electrical aging of the insulating layer. Advantageously, the smoothing conductive strand is partially covered by an insulating sheath to limit the skin effect and equalize the electrical potential. Advantageously, the risk of overheating due to internal contact between two smoothing conductive strands may be avoided.

Advantageously, a smoothing conductive strand is a conductor wire whose insulating sheath has been partially removed. This is particularly advantageous as it is sufficient to form a discontinuous longitudinal groove on a first conductor formed from only one of the conductor wires. In this way, the contact zones are shaped conveniently, evenly and precisely.

According to one aspect, the first conductor comprises at least two smoothing conductive strands, preferably at least three. According to one aspect, the first conductor comprises fewer than five smoothing conductive strands. According to one aspect, the number of smoothing conductor wires is greater than 10, preferably greater than 20.

The use of several smoothing conductive strands enables the electrical potential of the first semiconductor layer to be equalized in several contact zones. The equalization of electrical potential is thus more homogeneous and efficient. The use of a limited number of smoothing conductive strands limits the skin effect and proximity effect that may lead to overheating.

According to one aspect, since the first conductor has a periphery, the smoothing conductive strands are angularly distributed around the periphery of the first conductor. This allows the contact zones to be distributed. The equalization of electrical potential is thus more homogeneous and efficient.

According to one aspect, the smoothing conductive strand has the same cross-section as a conductive strand of a conductor wire. This allows electrical power to be conducted evenly.

According to one aspect, the smoothing conductive strand is a conductive strand of a conductor wire. The strands thus have the same characteristics for transmitting electrical power.

According to one aspect, the first conductor comprising at least a stranded wire of conductor wires twisted with a twisting pitch which is constant, the contact pitch is a multiple of the twisting pitch. This allows the insulated contact wire to be kept inside a stranded wire.

In one aspect, the contact pitch is equal to the twisting pitch. This allows for maximum smoothing.

According to one aspect, the cable comprises at least two discontinuous longitudinal grooves, preferably at least three longitudinal grooves. The equalization of electrical potential is thus more homogeneous and efficient.

According to one aspect, the uncovered portions are obtained by abrasion of the insulating sheath of the conductive strand of the conductor wire.

According to one aspect, the cable comprises at least one stranded wire of conductor wires, preferably a plurality of stranded wires of conductor wires. A stranded wire allows the position of the conductor wires in a cross-section to be varied so that a conductor wire is periodically located at the periphery. The magnetic fields are also balanced. The conductor wires alternate between an inner and an outer position.

According to one aspect, the stranded wire comprises at least one smoothing conductive strand joined to the conductor wires, which are by nature insulated.

According to one aspect, the cable comprises:
A second semiconductor layer surrounding the first insulating layer, and
A second conductor surrounding the second semiconductor layer.

This allows a “coaxial” cable to be formed, with a “skin effect” and a reduced proximity effect. Significant electrical power may be transmitted with increased electrical safety.

The invention also concerns an aircraft propulsion chain comprising a plurality of electrical devices connected by at least one power cable as previously described.

The invention also concerns an aircraft comprising a propulsion chain as described above.

The invention also relates to a method for manufacturing a longitudinal cable for transmitting electrical power, the method comprising the steps of:
Providing a first conductor comprising a plurality of conductor wires, each comprising a conductive strand which is covered with an insulating sheath so that the conductive strands are electrically insulated from one another
Forming at least one discontinuous longitudinal groove at the periphery uncovering the conductive strand of the conductor wires at the level of a contact zone, each uncovered conductive strand being a smoothing conductive strand, each smoothing conductive strand comprising longitudinal portions covered by an insulating sheath and uncovered longitudinal portions,
Surrounding the first conductor with a first semiconductor layer in such a way that the uncovered longitudinal portions being in contact with the first semiconductor layer at the level of the contact zone in such a way that the first semiconductor layer has the same electrical potential as the smoothing conductive strand, the contact zones being spaced apart by the same contact pitch,
Surrounding the first semiconductor layer with a first insulating layer.

According to one aspect, the method comprises a step of twisting the conductor wires and said at least one smoothing conductor to obtain the first conductor.

According to one aspect, the method comprises a step of twisting conductor wires to obtain the first conductor and a step of forming at least one discontinuous longitudinal groove uncovering said at least one conductive strand of the conductor wires at the periphery of the first conductor, each uncovered conductive strand being a smoothing conductive strand.

The twisting step is preferably carried out using conductor wires only.

According to one aspect, the step of forming said at least one discontinuous longitudinal groove is carried out by abrasion of the insulating sheath of the conductor wires.

### PRESENTATION OF FIGURES

The invention will be better understood on reading the following description, which is given by way of example, with reference to the following figures, given by way of non-limiting examples, in which identical references are given to similar objects.

FIG. 1 is a schematic representation of a coaxial cable according to the prior art.

FIG. 2 is a schematic representation of a Litz cable according to the prior art.

FIG. 3 is a schematic representation of an aircraft with power transmitting cables.

FIG. 4 is a schematic representation of a cross-section of a longitudinal cable according to one embodiment of the invention with a single smoothing conductive strand.

FIG. 5 is a close-up schematic of FIG. 4.

FIG. 6 is a schematic representation of a cross-section of a longitudinal cable according to one embodiment of the invention with several smoothing conductive strands.

FIG. 7 is a schematic cross-sectional representation of a first conductor in which the twisting of the smoothing conductive strand is shown.

FIG. 8 is a schematic top view of the first conductor shown in FIG. 7.

FIG. 9 is a schematic close-up view of a smoothing conductive strand according to a first embodiment.

FIG. 10 is a schematic cross-sectional representation of a first conductor in which the twisting of the smoothing conductive strand is shown.

FIG. 11 is a schematic representation of a device for abrading a first conductor to form three discontinuous longitudinal grooves.

FIG. 12 is a schematic representation of the first conductor with a discontinuous longitudinal groove.

FIG. 13 is a schematic representation of the abrading device shown in FIG. 11, seen in a plane transverse to the axis of the first conductor.

FIG. 14 is a schematic representation of the abrading device shown in FIG. 11, seen in a plane lateral to the axis of the first conductor.

FIG. 15 is a schematic close-up view of a smoothing conductive strand according to a second embodiment.

FIG. 16 is a schematic representation of a cross-section of a longitudinal cable with a single smoothing conductive strand according to the second embodiment.

FIG. 17 is a close-up schematic representation of FIG. 16.

FIG. 18 is a schematic representation of a coaxial cable with a single smoothing conductive strand.

FIG. 19 is a schematic representation of a coaxial cable with several smoothing conductive strands.

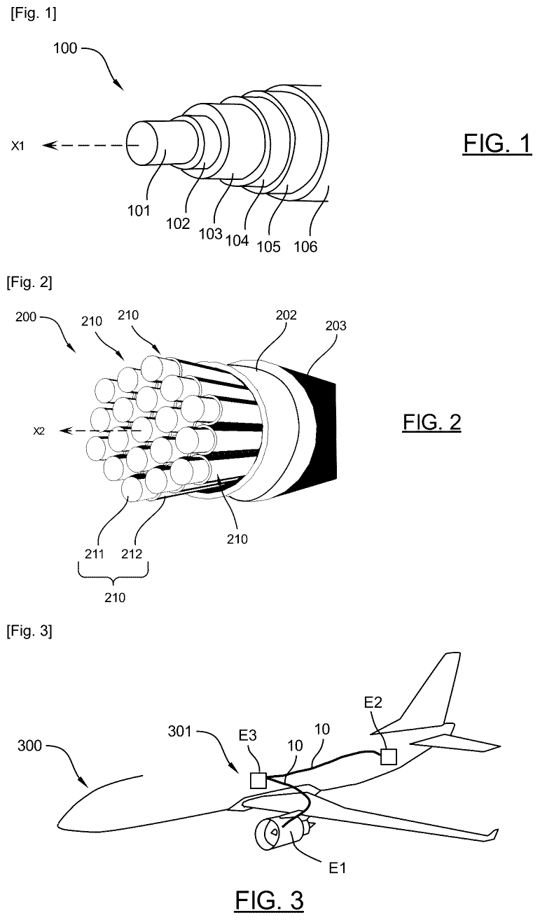

It should be noted that the figures set out the invention in detail for implementing the invention, said figures of course being able to be used to better define the invention where appropriate.

### DETAILED DESCRIPTION OF THE INVENTION

The invention concerns a longitudinal cable for transmitting electrical power, particularly in the aeronautical field. Of course, the invention is also applicable to other technical fields such as industry, shipping, railways, etc.

In reference to FIG. 3, an aircraft 300 is represented comprising a propulsion chain 301 comprising a plurality of electrical devices E1-E3 connected by a plurality of power cables 10. The electrical equipment E1-E3 may take the form of generators, power electronic devices, electric motors, etc.

The longitudinal cable 10 is configured to carry high power, in particular high voltage (230V-3000V) at high frequency (400 Hz-3000 Hz) with high current (100 A-1000 A). Such a longitudinal cable 10 is adapted to power an electric propulsion motor.

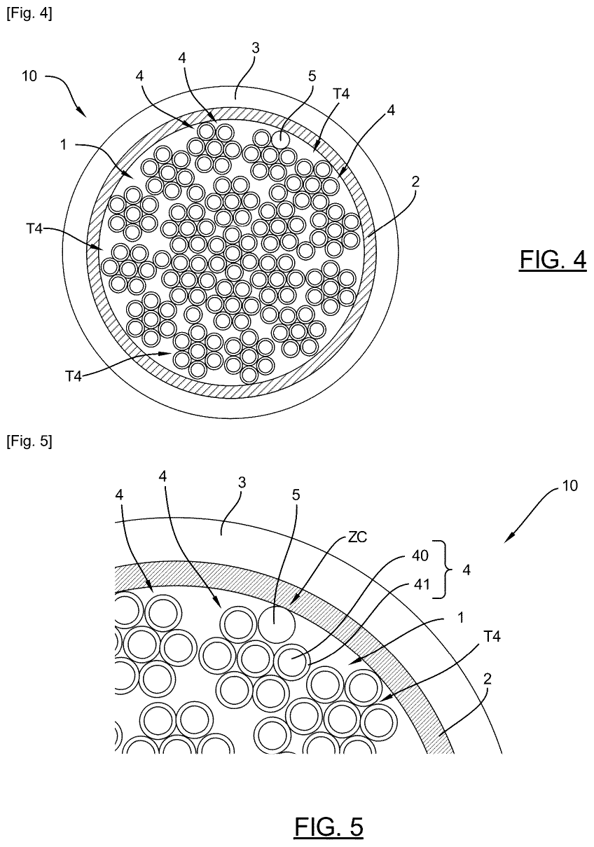

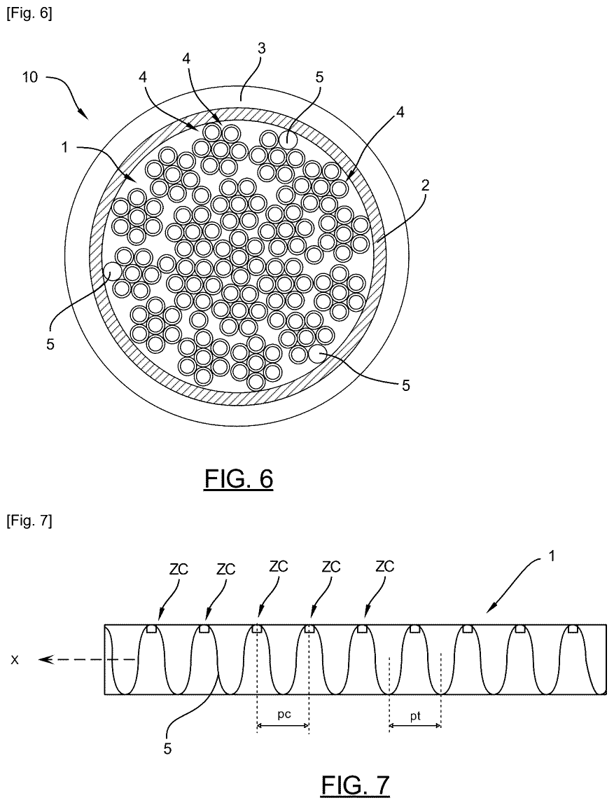

Reference is made to FIGS. 4 and 5, which show a cross-sectional view of an embodiment of a longitudinal cable 10 for transmitting electrical power. The longitudinal cable 10 extends along an axis X shown in FIG. 7.

As illustrated in FIGS. 4 and 5, the longitudinal cable 10 comprises a first conductor 1, a first semiconductor layer 2 surrounding the first conductor 1, and a first insulating layer 3 surrounding the first semiconductor layer 2. The longitudinal cable 10 is thus a single cable, as opposed to a coaxial cable, which will be presented later.

The first semiconductor layer 2 is formed around the first conductor 1 and is configured to form a smoothing screen for the electric field emanating from the first conductor 1. Preferably, the first layer of semiconductor 2 is made of polymeric insulating material such as perfluoroalkoxy (PFA), fluorinated ethylene propylene (FEP), ethylene tetrafluoroethylene (ETFE), silicones, fluorosilicones, rubbers, thermosets or thermoplastics of the polyetheretherketone (PEEK) type or others, or bio-sourced comprising additives that allow their electrical properties to be modified, such as carbon black fillers, nanoparticles, or metals to provide controlled electrical conductivity.

The first insulating layer 3 surrounding the first semiconductor layer 2 is configured to provide electrical insulation. Preferably, the first insulating layer 3 is made of polymeric insulating material such as perfluoroalkoxy (PFA), fluorinated ethylene propylene (FEP), ethylene tetrafluoroethylene (ETFE), silicones, fluorosilicones, rubbers, thermosets or thermoplastics such as polyetheretherketone (PEEK) or others, or bio-sourced. Preferably, it will be made of the same insulating material as the semiconductor layer, but will be free of conductive fillers. In order for the first insulating layer 3 to perform its function optimally, it is important that the first semiconductor layer 2 ensures efficient smoothing of the electric field emanating from the first conductor 1. The first conductor 1 has a periphery that is configured to contact the first semiconductor layer 2.

As illustrated in FIGS. 4 and 5, the first conductor 1 comprises a plurality of conductor wires 4 each comprising a conductive strand 40 which is covered by an insulating sheath 41 so that the conductive strands 40 are electrically insulated from one another. The conductor wires 4 are thus “Litz wires”, and allow the reduction of the skin and proximity effect that causes local heating. A conductive strand 40 may comprise one or more electrical wires.

In this example, the conductive strand 40 is made of a conductive material such as copper, aluminum, alloys or equivalent, preferably copper. The conductive strand 40 has a diameter of between 0.008 mm and 3 mm. The insulating sheath 41 is made of enamel, varnish or thermoplastics or equivalent, preferably Polyurethane (PUR) enamel or varnish, Polyesterimides (PES), Polyester imide (PEI), Polyamide imide (PAI), simple Polyimide (PI), aromatic Polyimide, or perfluoroalkoxy (PFA) or polyetheretherketone (PEEK) thermoplastics. The insulating sheath 41 has a thickness between 0.001 mm and 0.05 mm.

As shown in FIG. 5, the first conductor 1 also comprises at least one smoothing conductive strand 5 in contact with the first semiconductor layer 2 along at least one contact zone ZC, so that the first semiconductor layer 2 has the same electrical potential as the smoothing conductive strand 5. The electrical power is transmitted by the conductive strands 40 of the conductor wires 4, but also by the smoothing conductive strand(s) 5.

In this way, certain power conductors, called smoothing conductive strands 5, are in contact with the first semiconductor layer 2 so as to enable the first semiconductor layer 2 to smooth the electric field coming from the first conductor 1 and thus improve the electrical insulation implemented by the first insulating layer 3.

According one aspect, with reference to FIGS. 4 and 5, the longitudinal cable 10 comprises at least one stranded wire T4 of conductor wires 4, preferably a plurality of stranded wire T4 of conductor wires 4. With reference to FIG. 4, the conductor wires 4 and the smoothing conductive strand 5 are assembled and twisted together to form tendrils along the axis X of the longitudinal cable 10, as illustrated schematically in FIG. 7. In other words, at a given longitudinal position of the longitudinal cable 10, a conductor wire 4 and/or the smoothing conductive strand 5 is not located at the same position in a cross-section of the longitudinal cable 10. It goes without saying, however, that some conductor wires may not be twisted. The smoothing conductive strand(s) 5 are preferably all twisted. In a first conductor 1, the conductor wires 4 and the smoothing conductive strand(s) 5 can be twisted together into a single stranded wire or assembled into elementary stranded wire which are then themselves assembled and twisted to form an overall stranded wire.

Preferably, the smoothing conductive strand 5 has the same cross-section as a conductive strand 40 of a conductor wire 4. Advantageously, this allows each conductive strand 40, 5 to have similar characteristics, which improves service life and facilitates the transmission of electrical power.

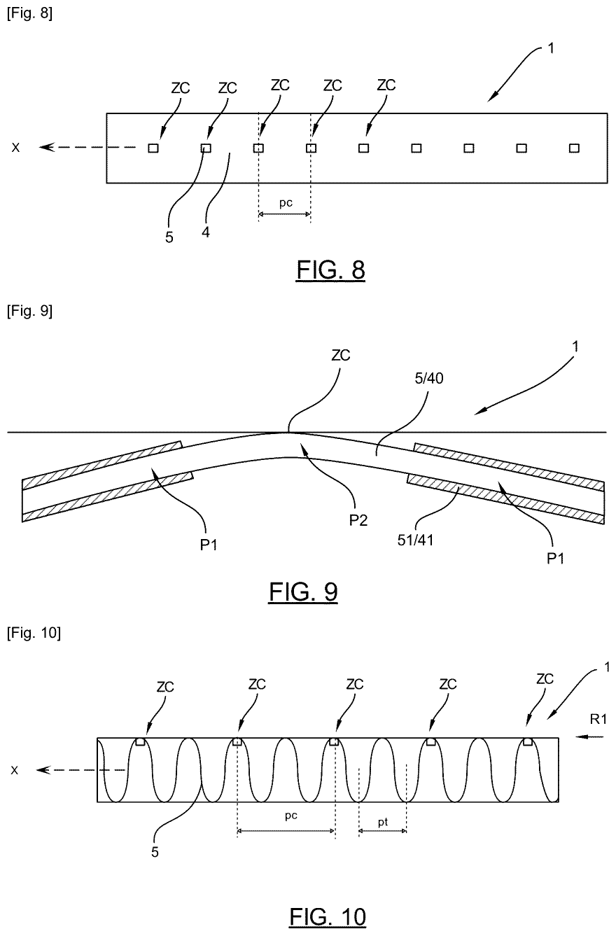

With reference to FIGS. 7 and 8, a smoothing conductive strand 5 is shown schematically, twisted with a constant twisting pitch pt in the first conductor 1. At each twisting pitch pt, the smoothing conductive strand 5 is periodically positioned at the periphery of the first conductor 1, i.e. in contact with the first semiconductor layer 2 (not shown) along a contact zone ZC. In this embodiment, the contact zones ZC are thus longitudinally spaced by a contact pitch pc which is equal to the twisting pitch pt. As shown in FIG. 8, the contact zones ZC are axially spaced by the contact pitch pc.

According to one variant, the first conductor 1 may comprise several smoothing conductive strands 5 angularly distributed around the periphery of the first conductor 1. FIG. 6 shows three smoothing conductors 5, angularly spaced by 120°. In this example, the contact zones of the smoothing conductors 5 belong to the same cross-sectional plane of the longitudinal cable 10. Nevertheless, it is preferable for the contact zones of different smoothing conductors 5 to belong to different planes, so as to distribute the contact zones longitudinally and enable efficient electrical potential setting of the first semiconductor layer 2.

With reference to FIG. 9, the smoothing conductive strand 5 comprises longitudinal portions P1 covered with an insulating sheath 51 and uncovered longitudinal portions P2. In particular, the presence of covered longitudinal portions P1 reduces the skin effect and the proximity effect and, consequently, heating. This means more electrical power may be transmitted.

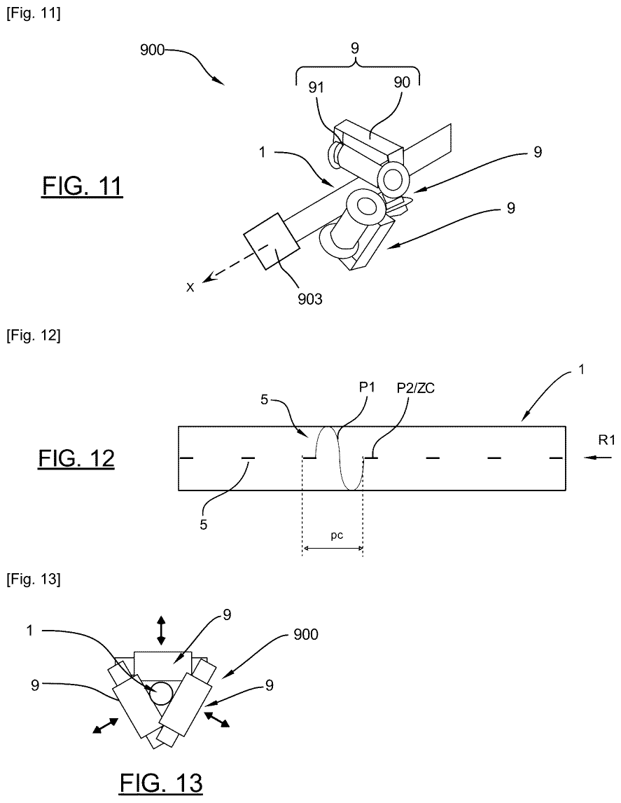

According to a first variant, the smoothing conductive strand 5 is formed independently. Preferably, the conductor wires 4 and the smoothing conductive strand 5 are assembled and twisted together to form tendrils along the axis X of the longitudinal cable 10 as shown in FIG. 12. The uncovered longitudinal portions P2 are positioned at the periphery of the first conductor 1 so as to be in contact with the first semiconductor layer 2 according to a plurality of contact zones ZC. To this end, the contact zones ZC are longitudinally spaced by a contact pitch pc which is equal to a multiple of the twisting pitch pt. By way of example, with reference to FIG. 10, the contact pitch pc is equal to twice the twisting pitch pt. The contact pitch pc may be determined according to specific constraints by specifying the position of the uncovered longitudinal portions P2.

The first conductor 1 is produced by integrating one or more smoothing conductive strands 5 at the periphery of the conductor wires 4. The assembly may then be assembled and twisted in the conventional way.

An example of a method for manufacturing a longitudinal cable 10 for transmitting electrical power will now be presented.

The method comprises the step of providing a first conductor 1 comprising a plurality of conductor wires 4 each comprising a conductive strand 40 which is covered with an insulating sheath 41 so that the conductive strands 40 are electrically insulated from one another and at least one smoothing conductive strand 5 located at the periphery of the first conductor 1.

The method includes a step consisting in assembling and twisting conductor wires 4 and said at least one smoothing conductor 5 to obtain the first conductor 1. The smoothing conductor 5 is a conductor comprising covered portions P1 and uncovered portions P2.

The method comprises a step consisting in surrounding the first conductor 1 with a first semiconductor layer 2 so that an uncovered portion P2 is in contact with the first semiconductor layer 2 according to at least one contact zone ZC so that the smoothing conductive strand 5 has the same electrical potential as the first semiconductor layer 2. The method includes a step of surrounding the first semiconductor layer 2 with an insulating layer 3. Preferably, this is done simultaneously in coextrusion.

This advantageously results in a “simple” longitudinal cable 10 that allows the transmission of electrical power and avoids any risk of overheating due to the “skin effect” and proximity effect, while allowing the smoothing of the electric field in order to increase electrical safety. The mass is reduced, as is the space taken up.

In practice, it is complex to achieve optimum twisting so that the uncovered longitudinal portions P2 are positioned precisely at the periphery of the first conductor 1 to make contact with the first semiconductor layer 2 at a contact pitch pc. According to one variant, the smoothing conductive strand 5 is a conductor wire 4 of a stranded wire of a conductor wire 4 whose insulating sheath 41 has been precisely and evenly removed locally.

An example of a method for manufacturing a longitudinal cable 10 for transmitting electrical power will now be presented.

The method comprises a step of providing a first conductor 1 comprising a plurality of conductor wires 4 each comprising a conductive strand 40 which is covered with an insulating sheath 41 so that the conductive strands 40 are electrically insulated from each other and at least one smoothing conductive strand 5 located at a periphery of the first conductor 1.

The method includes a step consisting in twisting conductor wires 4 and forming at least one discontinuous longitudinal groove R1 (FIG. 10) uncovering the conductive strand 40 of conductor wires 4 at the periphery of the first conductor 1, each uncovered conductive strand 40 being a smoothing conductive strand 5.

In other words, a stranded wire is formed using only identical conductor wires 4, which is very practical. A discontinuous longitudinal groove R1 is then formed to form smoothing conductive strands 5 comprising longitudinal portions P1 covered by an insulating sheath 51 and uncovered longitudinal portions P2. The formation of a longitudinal groove R1 enables the insulating sheath 41 to be removed from the conductor wires 4 locally and periodically around the periphery of the first conductor 1.

Referring to FIG. 12, the discontinuous longitudinal groove R1 comprises segments spaced by the contact pitch pc. Preferably, the contact pitch pc is equal to a multiple of the twisting pitch pt.

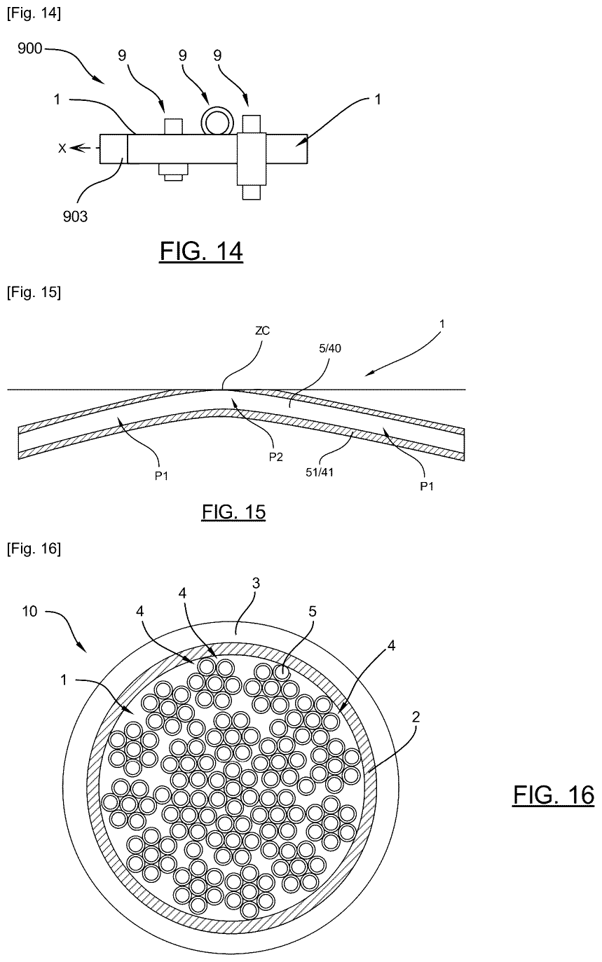

By way of example, with reference to FIGS. 11 to 14, we present an abrasion device 900 comprising three abrasion members 9 for simultaneously producing three discontinuous longitudinal grooves R1. It goes without saying that the number of abrasion members 9 could be different, as could their positions. The abrasion members 9 are preferably offset from the longitudinal cable axis 10 so that the contact zones ZC of the smoothing conductors 5 belong to different planes, so as to distribute the contact zones ZC longitudinally and enable efficient electrical potential setting of the first semiconductor layer 2. In this example, the abrasion device 900 produces three discontinuous, angularly-spaced longitudinal grooves R1.

The abrasion members 9 are positioned around the first conductor 1. Each abrasion member 9 is configured to come into contact with a conductor wire 4 of the periphery in a plane transverse to the first conductor 1 in which the abrasion member 9 may move. Each abrasion member 9 is configured to remove the insulation sheath 41 from the conductor wire 4 with which it comes into contact, as illustrated in FIG. 13. Referring to FIG. 15, after abrasion, the conductive strand 40 is stripped of its insulating sheath 41 at the periphery of the first conductor 1 to form an uncovered portion P2, i.e., a contact zone ZC.

In this embodiment, each abrasion member 9 comprises a frame 90 radially movable with respect to the axis X of the first conductor 1 and an abrasive roller 91 driven in rotation with respect to the frame 90. It goes without saying that each abrasion member 9 could take a different form.

The abrading device 900 comprises a drive member 903 for the stranded wire of conductor wires 4, i.e. the first conductor 1, with a drive pitch corresponding to the contact pitch pc. Thus, each abrasion member 9 may form a contact zone ZC with a contact pitch pc that is very regular, preferably a multiple of the twisting pitch pt. The drive member 903, for example a motorized winder, is used to shift the longitudinal portions of the first conductor 1 in contact with the abrasion members 9.

Once the first conductor 1 has been obtained by one of the methods presented above, the method includes a step consisting in surrounding the first conductor 1 with a first semiconductor layer 2 so that the smoothing conductive strand 5 is in contact with the first semiconductor layer 2 according to at least one contact zone ZC as illustrated in FIGS. 16 and 17. The smoothing conductive strand 5 thus has the same electrical potential as the first semiconductor layer 2.

The method includes a step of surrounding the first semiconductor layer 2 with an insulating layer 3. Preferably, this is done simultaneously in coextrusion.

This advantageously results in a “simple” longitudinal cable 10 that allows the transmission of electrical power and avoids any risk of overheating due to the “skin effect” and proximity effect, while allowing the smoothing of the electric field in order to increase electrical safety. The manufacture of the longitudinal cable 10 is practical given that it is sufficient to form the uncovered portions P2 on a stranded wire of conductor wires 4 that may be obtained in a practical manner.

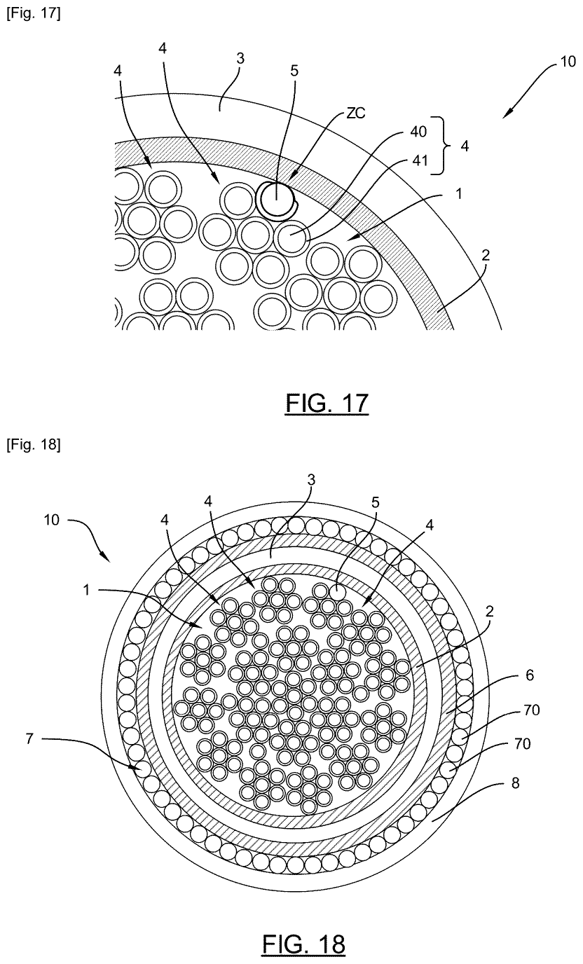

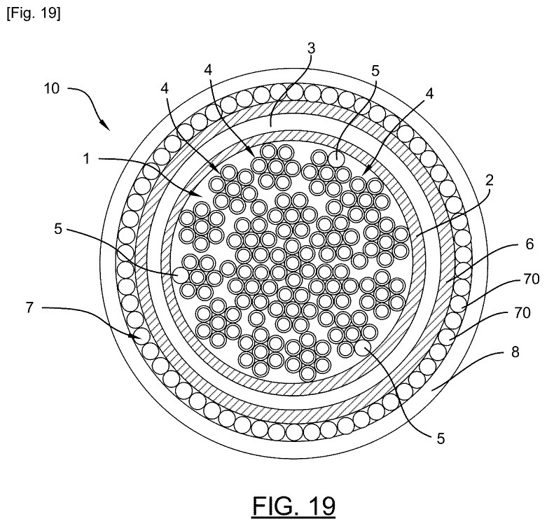

With reference to FIGS. 18 and 19, a longitudinal cable 10 of the “coaxial” type may also be obtained which comprises a second semiconductor layer 6 surrounding the insulating layer 3, a second conductor 7 surrounding the second semiconductor layer 6 and an insulating protective sheath 8 surrounding the second conductor 7. The second conductor 7 may be of various types, such as a braid made up of cylindrical or flat strands, a covering made up of cylindrical or flat strands, a strap, or an assembly of these different technologies. According to one aspect, the second conductor 7 is dimensioned to provide electromagnetic and lightning protection. The material of the insulating sheath 8 may be the same as that of the insulating layer 3, or another material from among polymers such as PFA (perfluoroalkoxy), FEP (fluorinated ethylene propylene), ETFE (ethylene tetrafluoroethylene), silicones, fluorosilicones, rubbers, thermosets or thermoplastics such as PEEK or others, or bio-sourced materials. The insulating outer sheath 8 may also be made from materials used primarily for mechanical protection in braided form, such as Kevlar (trade name), nomex (trade name), glass fibers, aramid fibers, polyamide, or any other material suitable for the application.

In particular, it may comprise a plurality of conductor wires 70 in contact with the second semiconductor layer 6, which is connected at the end to a reference potential so that the second semiconductor layer 6 is itself at this potential.

Thanks to the invention, any additional warming up due to the “skin effect” and proximity effect is eliminated thanks to equipotentiality between the conductor and the semiconductor layer, allowing an increase in the performance of the electrical insulation by reducing the phenomena of partial discharges, the phenomena of local reinforcement of the electric field, the phenomena of space charges and the electrical aging of the insulating layer.

1. A longitudinal cable for transmitting electrical power, the longitudinal cable comprising:
a first conductor,
a first semiconductor layer surrounding the first conductor, and
a first insulating layer surrounding the first semiconductor layer,
the first conductor including a periphery in contact with the first semiconductor layer, the first conductor comprising:
a plurality of conductor wires each comprising a conductive strand which is covered by an insulating sheath so that the conductive strands are electrically insulated from one another,
the first conductor comprising at least one discontinuous longitudinal groove at the periphery uncovering the conductive strand of the conductor wires at a level of a contact zone, each of the uncovered conductive strands being a smoothing conductive strand, each of the smoothing conductive strands comprising longitudinal portions covered by the insulating sheath and uncovered longitudinal portions, the uncovered longitudinal portions being in contact with the first semiconductor layer at the level of the contact zone so that the first semiconductor layer has a same electrical potential as the smoothing conductive strand, the contact zones being spaced apart by a same contact pitch.

2. The longitudinal cable according to claim 1, wherein the first conductor comprises at least a stranded wire of conductor wires twisted so as to define with a twisting pitch which is constant, and wherein the contact pitch is a multiple of the twisting pitch.

3. The longitudinal cable according to claim 2, wherein the contact pitch is equal to the twisting pitch.

4. The longitudinal cable according to claim 1, wherein the first conductor comprises at least two of the discontinuous longitudinal grooves.

5. The longitudinal cable according to claim 4, wherein the discontinuous longitudinal grooves are angularly distributed around the periphery of the first conductor.

6. The longitudinal cable according to claim 1, wherein the uncovered portions are obtained by abrasion of the insulation sheath of the conductive strand of the conductor wire.

7. The longitudinal cable according to claim 1, further comprising: a second semiconductor layer surrounding the first insulating layer. and
a second conductor surrounding the second semiconductor layer.

8. An aircraft propulsion chain, comprising:
a plurality of electrical devices connected by at least one of the longitudinal cables according to claim 1.

9. A method for manufacturing a longitudinal cable for transmitting electrical power, the method comprising the steps of:
providing a first conductor comprising a plurality of conductor wires each comprising a conductive strand which is covered by an insulating sheath so that the conductive strands are electrically insulated from one another,
forming at least one discontinuous longitudinal groove at a periphery uncovering the conductive strand of the conductor wires at a level of a contact zone, each of the uncovered conductive strands being a smoothing conductive strand, each of the smoothing conductive strands comprising longitudinal portions covered by the insulating sheath and uncovered longitudinal portions,
surrounding the first conductor with a first semiconductor layer in such a way that the uncovered longitudinal portions are in contact with the first semiconductor layer at the level of the contact zone in such a way that the first semiconductor layer has a same electrical potential as the smoothing conductive strand, the contact zones being spaced apart by a same contact pitch, and
surrounding the first semiconductor layer with a first insulating layer.

10. The manufacturing method according to claim 9. further comprising:
twisting conductor wires to obtain the first conductor, and a step of
forming at least one discontinuous longitudinal groove uncovering said at least one conductive strand of the conductor wires at the periphery of the first conductor, each uncovered conductive strand being a smoothing conductive strand.

11. The manufacturing method according to claim 10, wherein said at least one discontinuous longitudinal groove is produced by abrasion of the insulation sheath of the conductor wires.

12. The longitudinal cable according to claim 1, wherein the first conductor comprises at least three longitudinal grooves.
